(19) United States
(12) Patent Application Publication
(10) Pub. No.: US 2017/0103488 A1
(43) Pub. Date: Apr. 13, 2017

(54) SECURE AND ANONYMOUS MESSAGING SYSTEM AND METHOD

(71) Applicant: INSPIRIT GROUP, LLC, Bedminster, NJ (US)

(72) Inventor: Todd SCHOBEL, Califon, NJ (US)

(21) Appl. No.: 15/200,622

(22) Filed: Jul. 1, 2016

Related U.S. Application Data
(63) Continuation-in-part of application No. 14/026,487, filed on Sep. 13, 2013.
(60) Provisional application No. 61/811,262, filed on Apr. 12, 2013.

(51) Int. Cl. G06Q 50/26; H04L 29/06

(52) U.S. Cl. CPC G06Q 50/265; H04L 63/0428

(57) ABSTRACT

Systems, methods, apparatuses, and computer program products for reporting incident(s) of illegal, unethical, harmful or other inappropriate conduct are provided. One method includes creating, by a server, a record to identify a user of an application for reporting at least one incident of illegal, unethical, harmful or other inappropriate conduct. The creating of the record further comprises assigning at least one of: a unique code used to anonymously identify a user that is submitting a report of the at least one incident, and/or a unique messenger ID for use by the user to anonymously send and receive real-time messages via a secure, anonymous, and two-way communication session.

### CROSS REFERENCE TO RELATED APPLICATIONS

This application is Continuation-in-Part of U.S. Non-Provisional patent application Ser. No. 14/026,487, filed on Sep. 13, 2013, which in turn claims the benefit of U.S. Provisional Patent Application No. 61/811,262, filed on Apr. 12, 2013. The entire contents of these earlier filed applications are hereby incorporated by reference in their entirety.

### BACKGROUND

Field

Some embodiments of the present invention relate to the field of computer-implemented methods and computer systems for reporting and/or countering threats and/or abuse. More particularly, certain embodiments enable smart phones and other computer devices to be used for the response to and reporting of incidents of harmful, inappropriate, unethical, harassment, illegal, and/or other inappropriate conduct.

Description of the Related Art

Advances in computer and telecommunications technology in recent decades has greatly exacerbated the effects of bullying on individuals, such as children, pre-teens and adolescents. Gone are the days when individuals faced bullies only at school or work, and could retreat into the shelter of their homes to escape them. The internet, e-mail, texting and social media now expose people, including minors, to threatening and abusive communications on a continual basis. And the impact of such “cyber-bullying”is all too often tragically life-threatening—inducing severe depression and suicidal reactions in the victims.

Efforts by parents, school administrators, and businesses to curtail cyber-bullying, harassment, or abuse, are frequently frustrated by the reluctance of the victims to report such incidents, whether due to feelings of helplessness or fear of retribution. What is needed is a system that empowers the victim to respond quickly and forcefully against the offending party, and simultaneously notify parents, school officials, human resources departments, and police of the incident and the victim's response so as to deter retribution. Since studies have shown that victims of cyber-bullying are less likely to report or respond to an incident with the passage of time, an instant response/reporting capability is essential to the effectiveness of an anti-bullying system.

Similarly, victims or witnesses of unethical or illegal conduct occurring within a business or organization may be reluctant to come forward due to fear of retaliation or losing their job or position. Therefore, systems are also needed that allow victims, witnesses, or other interested individuals to reliably and quickly report incidents of illegal, unethical, or other harmful or inappropriate conduct, with the possibility of remaining anonymous.

### SUMMARY

One embodiment is directed to a method, which may include receiving, by at least one server, a user report of at least one incident of illegal, unethical, harmful or other inappropriate conduct, and creating, by the at least one server, an incident report based on the received user report. The user report includes metadata comprising a unique code used to anonymously identify a user that the user report is received from.

Another embodiment is directed to an apparatus including at least one processor and at least one memory including computer program code. The at least one memory and the computer program code are configured, with the at least one processor, to cause the apparatus at least to receive a user report of at least one incident of illegal, unethical, harmful or other inappropriate conduct, and to create an incident report based on the received user report. The user report includes metadata comprising a unique code used to anonymously identify a user that the user report is received from.

Another embodiment is directed to a computer program, embodied on a non-transitory computer readable medium. The computer program is configured to control a processor to perform a process, which includes receiving a user report of at least one incident of illegal, unethical, harmful or other inappropriate conduct, and creating an incident report based on the received user report. The user report includes metadata comprising a unique code used to anonymously identify a user that the user report is received from.

### BRIEF DESCRIPTION OF THE DRAWINGS

For proper understanding of the invention, reference should be made to the accompanying drawings, wherein:

FIGS. 1A-1D illustrate a series of exemplary wireframes depicting initial setup of the application software of an embodiment of the present invention;

FIGS. 2A-2E illustrate a series of exemplary wire frames depicting how the application software of an embodiment of the present invention is launched;

FIGS. 3A-3D illustrate a series of exemplary wireframes depicting how the application software of an embodiment of the present invention inputs and assigns contacts to each of its functional modules;

FIGS. 4A-4H illustrate a series of exemplary wireframes depicting the operation of the STOPit module;

FIGS. 5A-51 illustrate a series of exemplary wireframes depicting the operation of the FRIENDit module;

FIGS. 6A-6B illustrate exemplary wire frames depicting the operation of the HELPit module;

FIGS. 7A-71 illustrate a series of exemplary wireframes depicting the operation of the REPORTit module;

FIGS. 8A and 8B illustrate exemplary wireframes depicting the operation of the Setup/Help function;

FIG. 9 illustrates an example screen depicting the operation of the DOCUMENTit module in a school version of an embodiment of the present invention;

FIG. 10 illustrates an example screen depicting the operation of the DOCUMENTit module in a school version, according to another embodiment of the present invention;

FIG. 11 illustrates an example block diagram of an apparatus, according to an embodiment;

FIG. 12 illustrates an example block diagram of an apparatus, according to another embodiment;

FIGS. 13A-13D illustrate example screens depicting interfaces of a mobile app, according to an embodiment;

FIG. 14 illustrates an example screen depicting interfaces of an event management and reporting system, according to an embodiment;

FIGS. 15A-15B illustrate example screens depicting interfaces of an event management and reporting system, according to another embodiment; and

FIGS. 16A-16B illustrate example screens depicting interfaces of an event management and reporting system, according to another embodiment.

### DETAILED DESCRIPTION

It will be readily understood that the components of the invention, as generally described and illustrated in the figures herein, may be arranged and designed in a wide variety of different configurations. Thus, the following detailed description of some embodiments of systems, methods, apparatuses, and computer program products for reporting incident(s) of bullying, cyber-bullying, harassment, and/or other harmful conduct, as represented in the attached figures, is not intended to limit the scope of the invention, but is merely representative of selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Certain embodiments of the present invention provide a method and system of rapid reporting and response to incidents of harmful, inappropriate, unethical, harassment, illegal, or other detrimental conduct by means of a user device, such as a smartphone (e.g., iPhone™ or Android™ device), a computer, or a tablet, running application software. The application software, which is constantly running or available for launch on the device of the user, enables the user to instantly initiate response and reporting of an incident from a touchscreen menu, for example.

The term “application” or “application software”, in the context of the present specification, may refer to an app, smart client, thin client, web browser, or any other software based application executed on a computing device, such as a desktop computer, laptop computer, tablet computer, smart phone, smart watch or other wearable communication device, etc.

The term “server”, in the context of the present specification, may refer to a computer or device on a network that manages network resources and may be any type of server, such as a web server, local service acting as a server which saves content such as web pages or images, e-mails, etc. locally, a remote cache server such as a dedicated network server, etc.

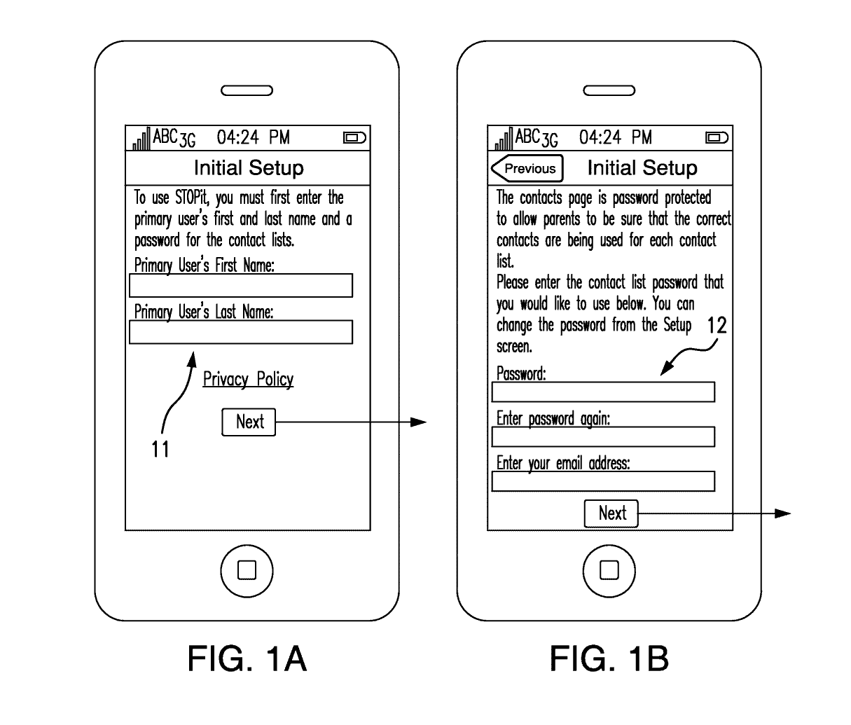

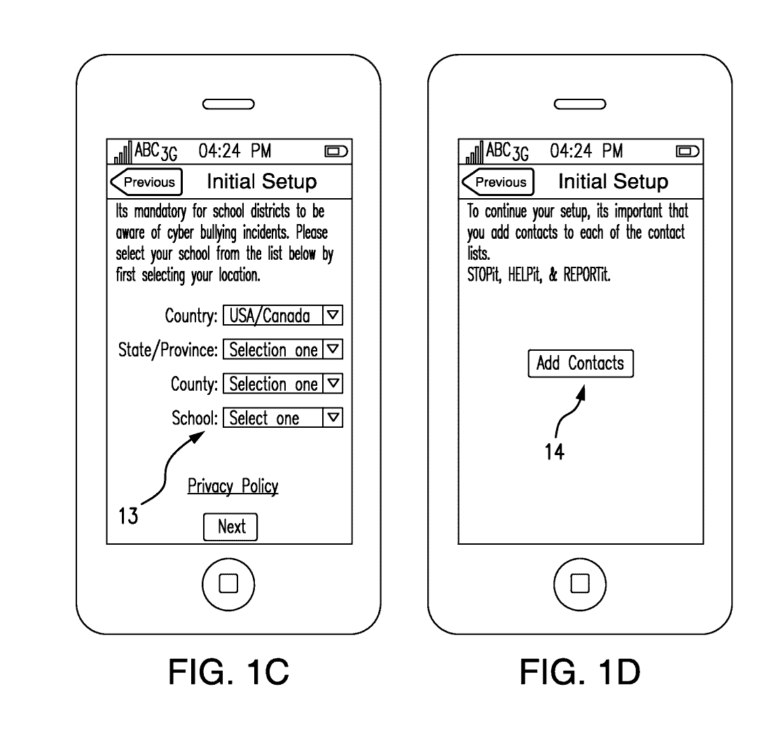

Referring to FIGS. 1A-1D, the Initial Setup screens require the input of user name 11, password 12 and school identification 13. Then the user is prompted 14 to add contacts to contact lists for each of the application modules. A check is performed with the server to determine if the identified school has designated a School Cyberbully Contact, and if it has, that contact is added to all of the contact lists.

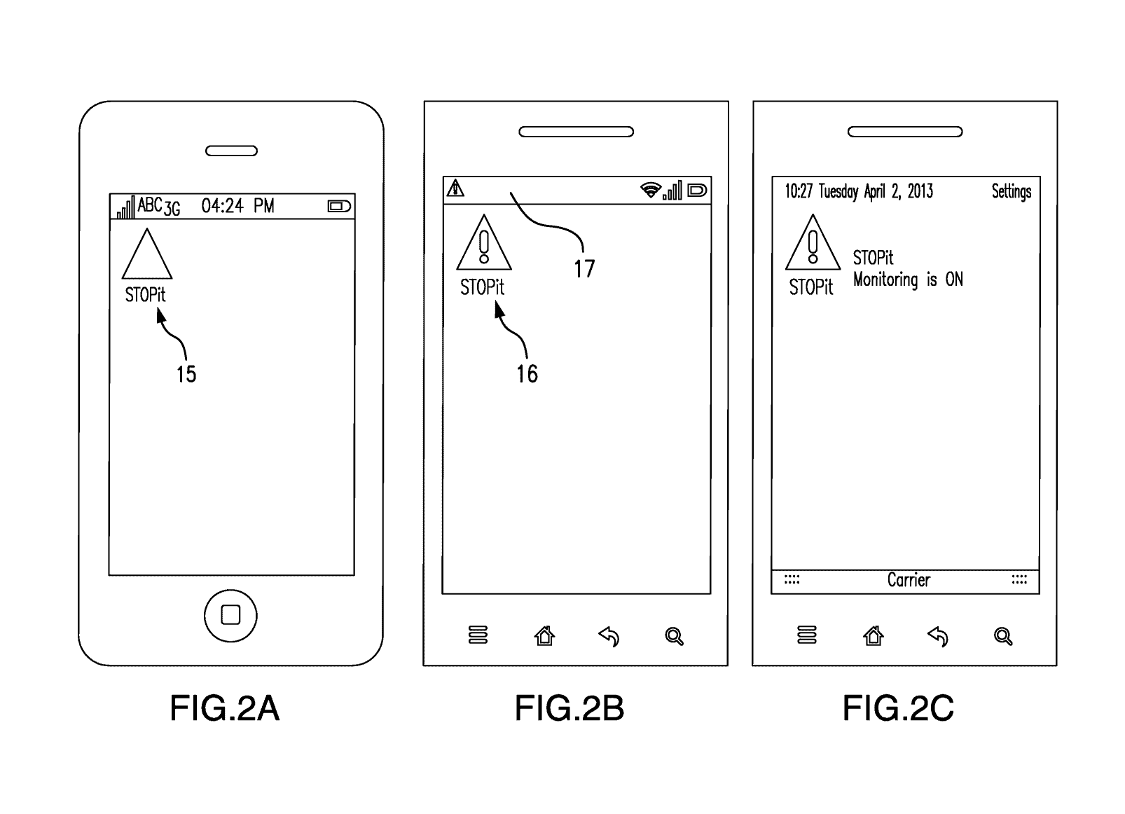

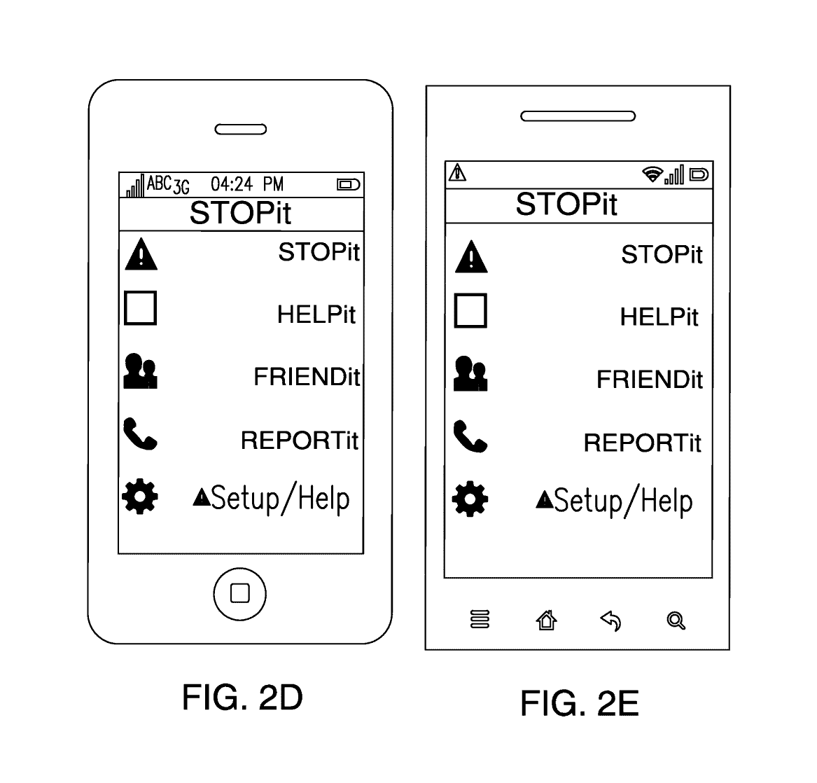

Referring to FIGS. 2A-2E, the launching of the application is depicted on an exemplary iPhone™ (round-cornered frame) and Android™ (square-cornered frame). In the former, the application is a standard application 15 that needs to be launched (as shown in FIG. 2A), while in the latter it is both a standard application 16 as well as a running application in the notification area 17 (as shown in FIGS. 2B and 2C, respectively). Upon startup, the application will contact the server to check the status of the School Cyberbully Contact and will enable/disable the contact based on that status. As shown in FIGS. 2D and 2E, the home screen for the application is the same for both iPhone™ and Android™ devices, regardless of how the application is launched.

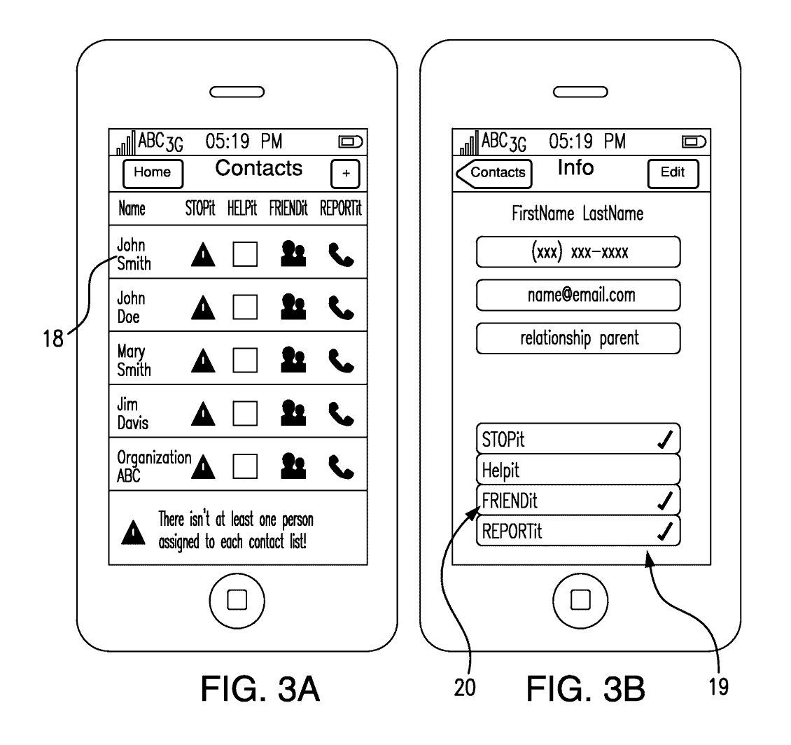

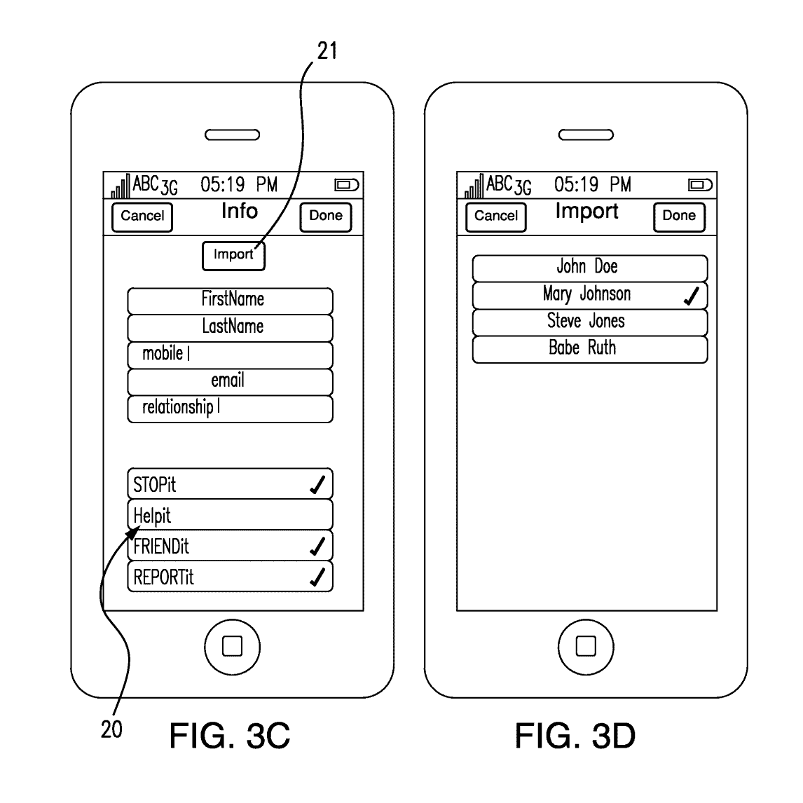

FIGS. 3A-3D depict exemplary screens used for populating the contact lists for each of the application's functional modules. Clicking on a contact's name 18 will take the user to an information page 19 for that contact. On the information page 19 appear entries for the functional modules 20, which are here listed as STOPit, HELPit, FRIENDit and REPORTit. Module entries 20 when clicked will show a check mark, indicating that the contact has been added to the contact list for that module. Clicking again on the module entry 20 will remove the checkmark and delete the contact from that module's list.

As shown in FIGS. 3C and 3D, clicking on an “Import” button 21 will allow the user to access the contacts stored on their smartphone and import those contacts into the contact lists of one or more of the application modules, again using the module entries 20.

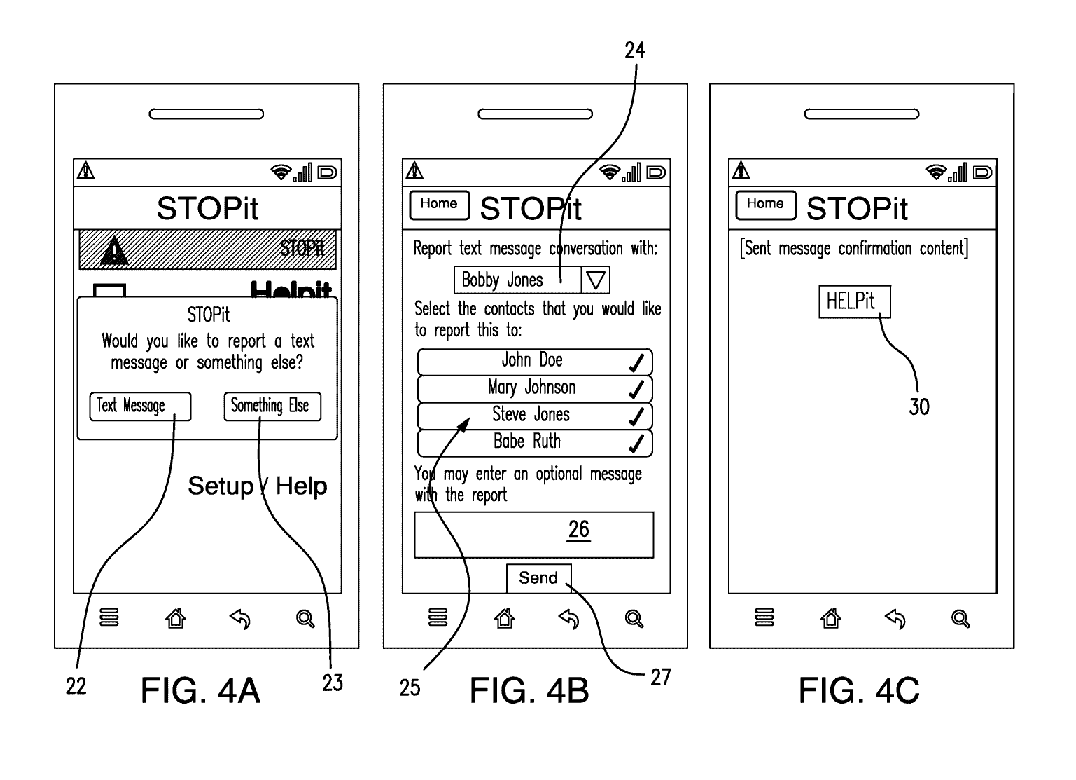

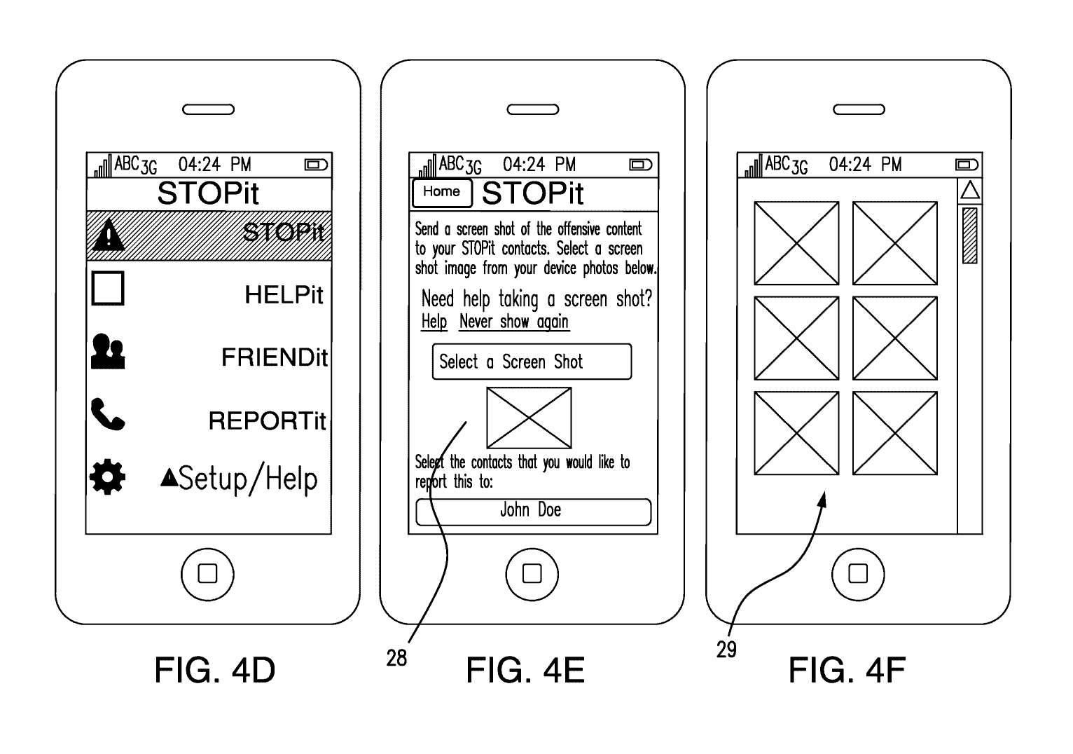

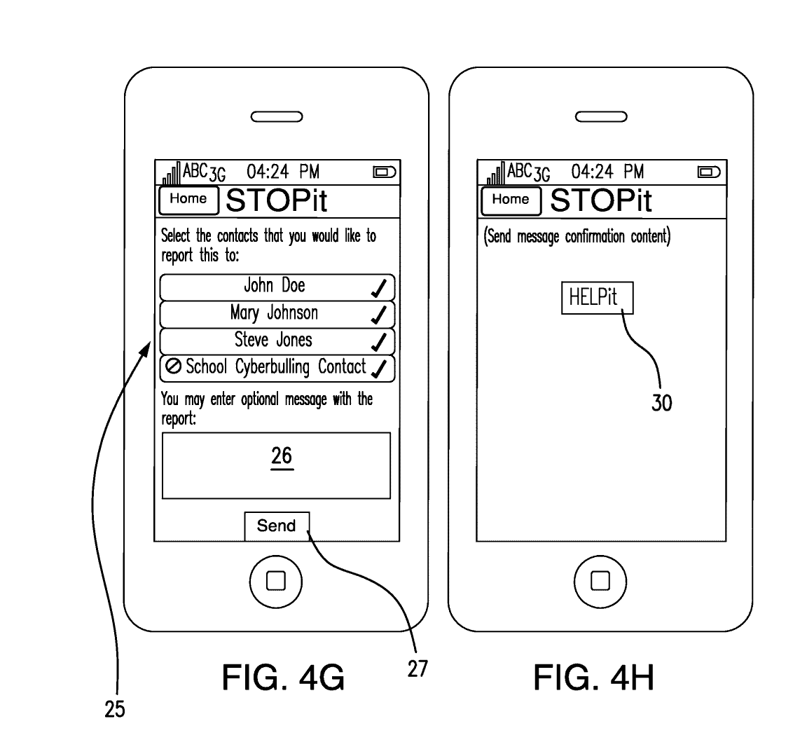

FIGS. 4A-4H illustrate the use of the STOPit module with iPhone™ (round-cornered frame) and Android™ (square-cornered frame) type smartphones. In Android™ type devices (FIGS. 4A-4C), the STOPit module first prompts the user to indicate whether the cyber-bullying communication is a text message 22 or something else 23.

Clicking on “text message” 22 will bring the user to the screen shown in FIG. 4B, which has a dropdown list 24 of the phone numbers from which the user's phone has received SMS text messages, in chronological order with the most recent at the top. If the sender's phone number appears on one of the application's contact lists, the dropdown list 24 will show the sender's name. On the same screen, the user can designate contacts from the STOPit contact list 25 to receive the report of this incident, and can add an optional message 26. Clicking the send button 27 at the bottom of this screen causes the STOPit module to have the smartphone send a pre-composed “cease-and-desist” response message to the sender of the cyber-bullying text. The STOPit module concurrently will also send via text and e-mail to all designated contacts copies of the user's response message and the recent text messages exchanged between the user and the cyber-bully.

If the user has an iPhone™ type device, or if the user of an Android™ type device is responding to a cyber-bullying communication that is something other than a text message, the exemplary STOPit response process proceeds through the screens depicted in FIGS. 4D-4G. The STOPit module prompts the user to take one or more screen shots of the offensive material 28, which may be an e-mail or a posting on a social media website. Screenshots 29 are then selected for inclusion in the incident report and contacts are designated from the STOPit list to receive the report 25. An optional message 26 to go with the report can also be added by the user. When the user clicks the send button 27, the canned “cease-and-desist” text message is sent by the phone to the cyber-bully. Concurrently, the STOPit module causes the smartphone to send a copy of the “cease-and-desist” message and the screen shot(s) of the offensive material to the user's STOPit contact list.

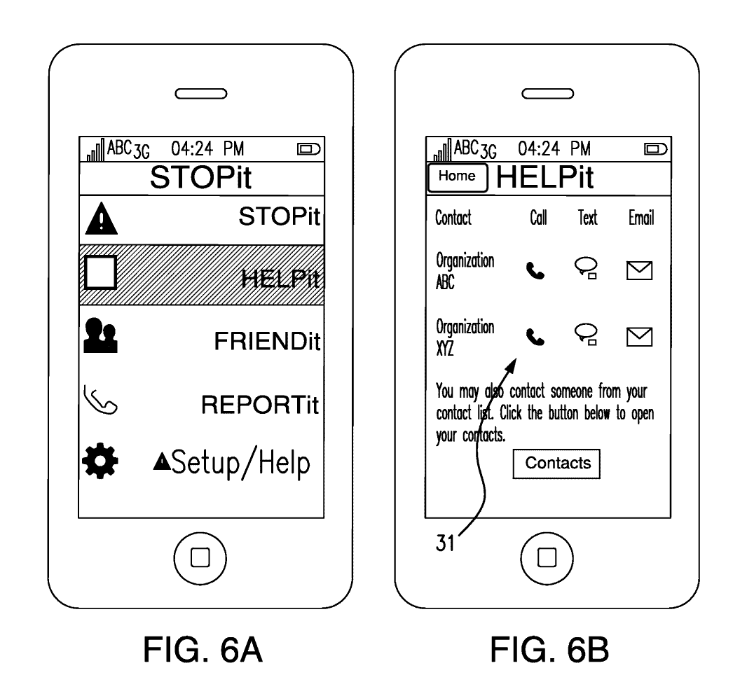

As shown in FIGS. 4C and 4H, when the STOPit response/reporting process is completed, the user is taken to a screen with a HELPit button 30, which when clicked activates the application's HELPit module. As depicted in FIGS. 6A and 6B, the HELPit module enables the user to seek aid or counseling from designated contacts comprising hotlines or networks for victims of cyber-bullying 31.

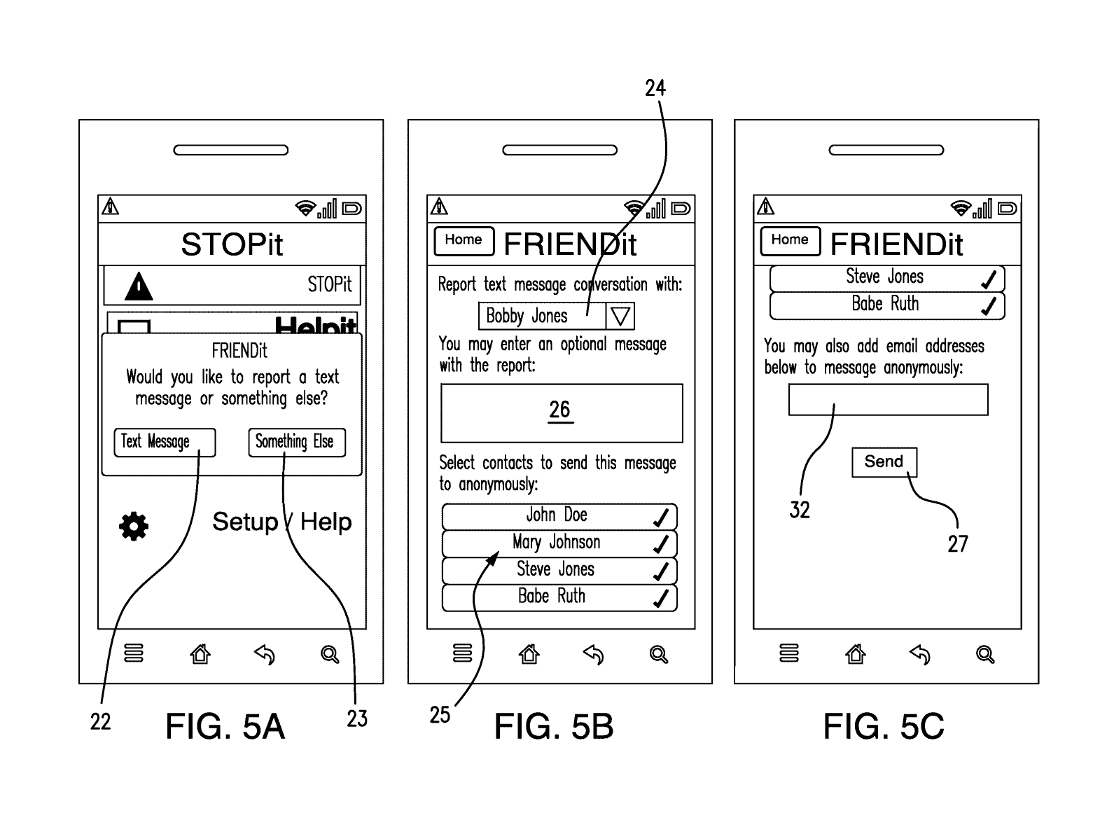

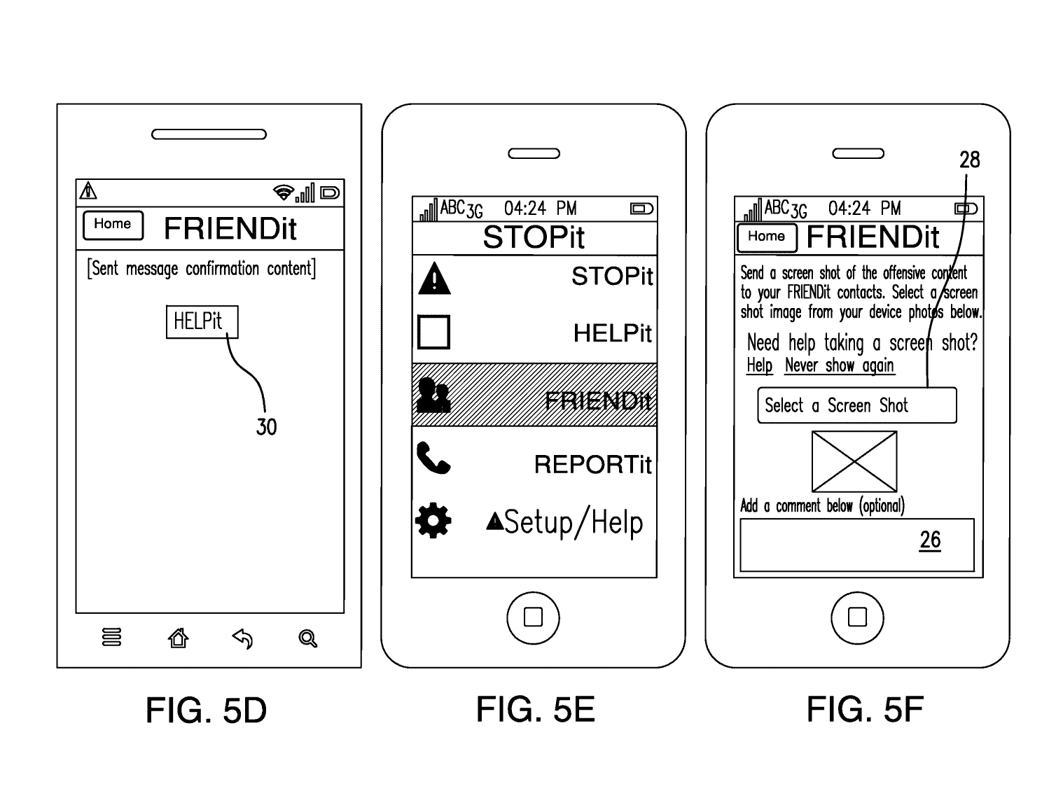

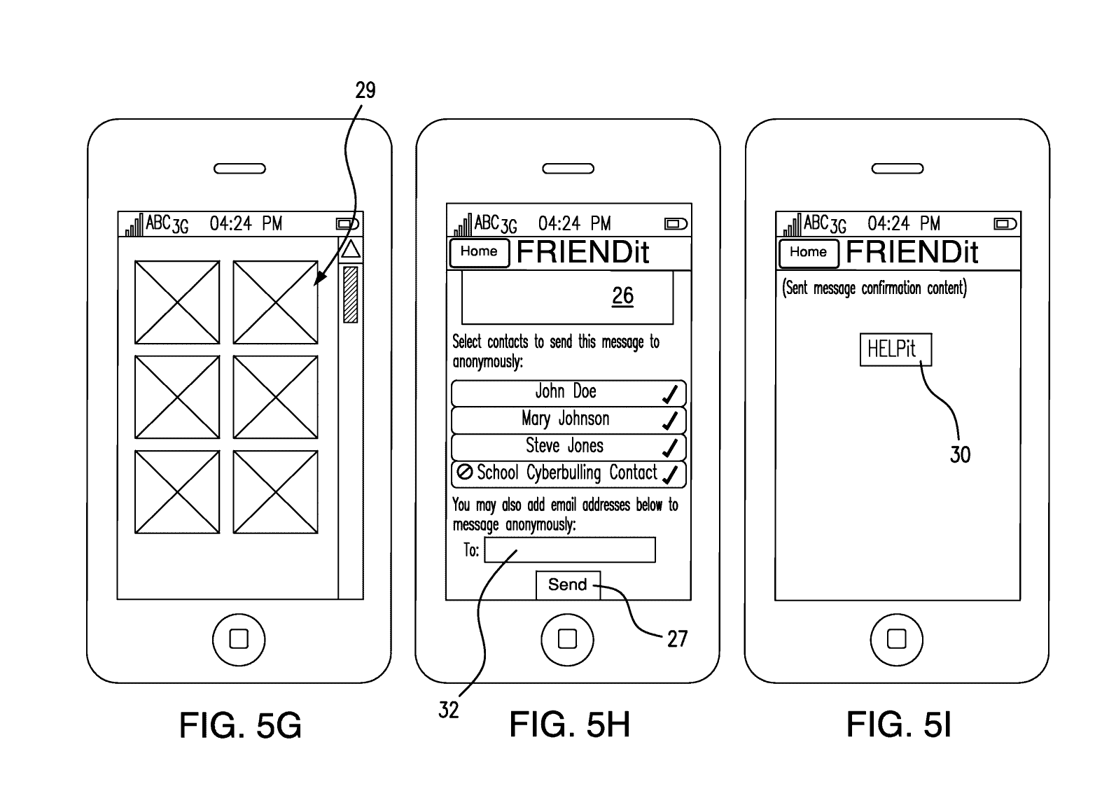

FIGS. 5A-51 illustrate the operations of the application's FRIENDit module. In this case the user is anonymously reporting a cyber-bullying incident directed not at themselves but at another victim. The FRIENDit screens follow the same processes that are described above for the STOPit module, except that the “send” screen (FIG. 5H) allows the entry of e-mail addresses 32 as recipients of the report in addition to the FRIENDit contact list. Another difference is that the FRIENDit report does not include a response message to the cyber-bully, and the report is sent anonymously through the application server, rather than from the user's e-mail/text account.

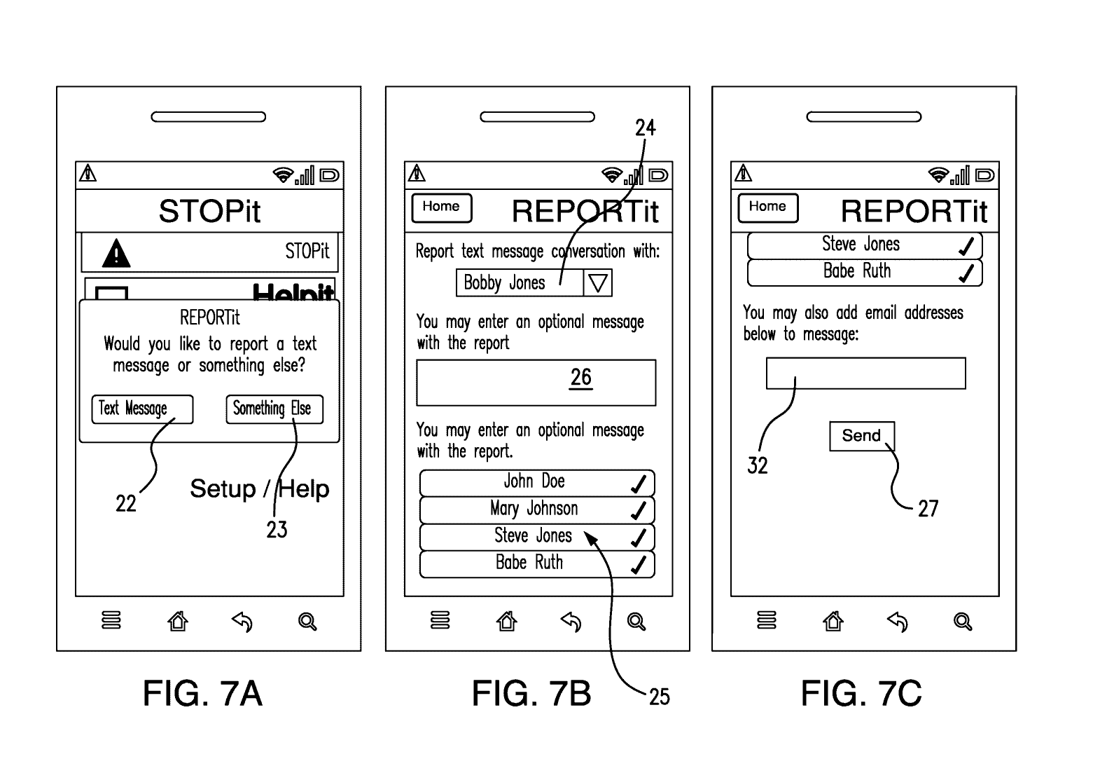

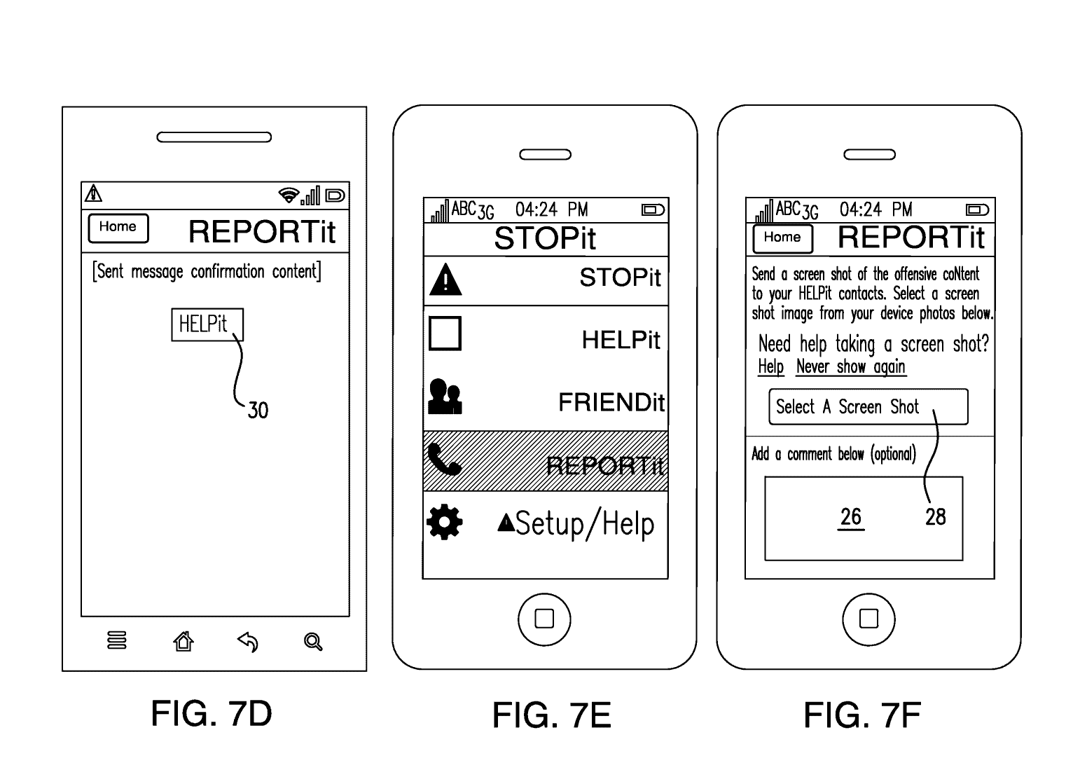

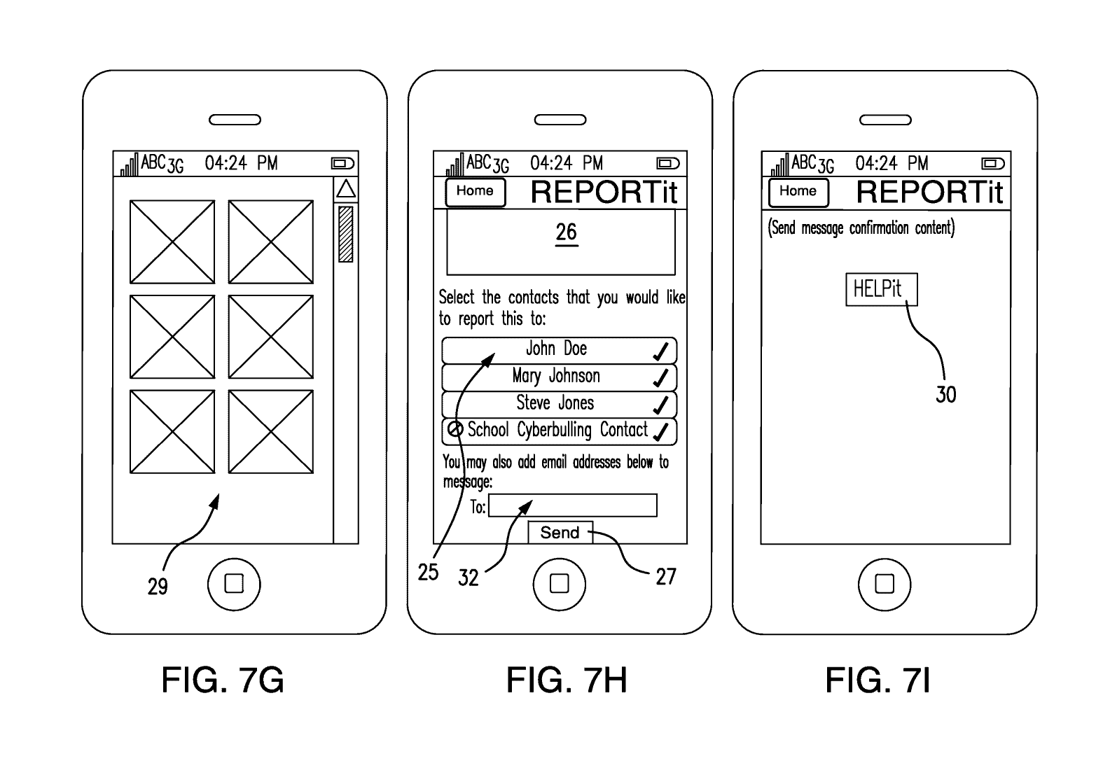

As depicted in FIGS. 7A-71, the REPORTit module follows the same process as the FRIENDit module, except that the report is not made anonymously. In this case, as in the FRIENDit module, the user is reporting cyber-bullying or predatory communications pertaining not to themselves but to another victim.

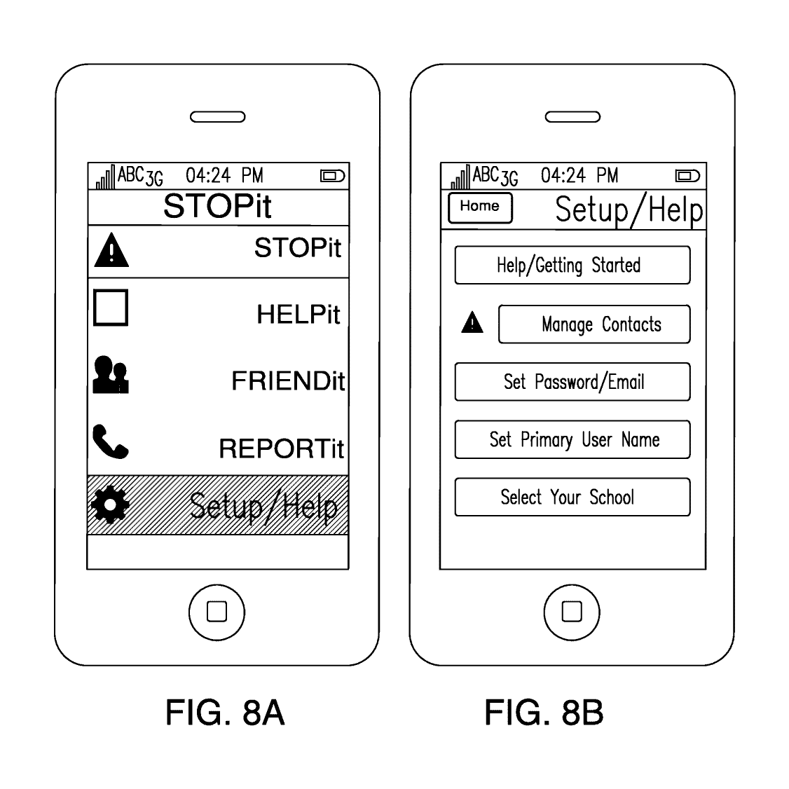

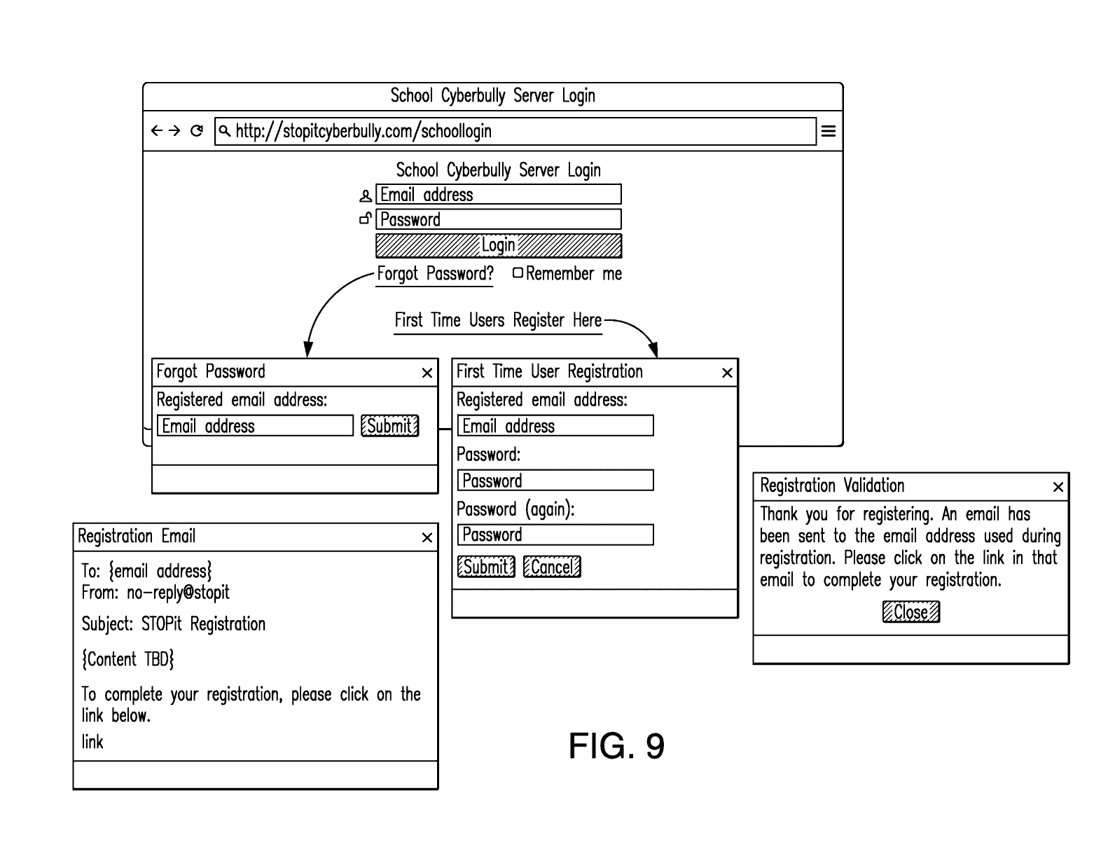

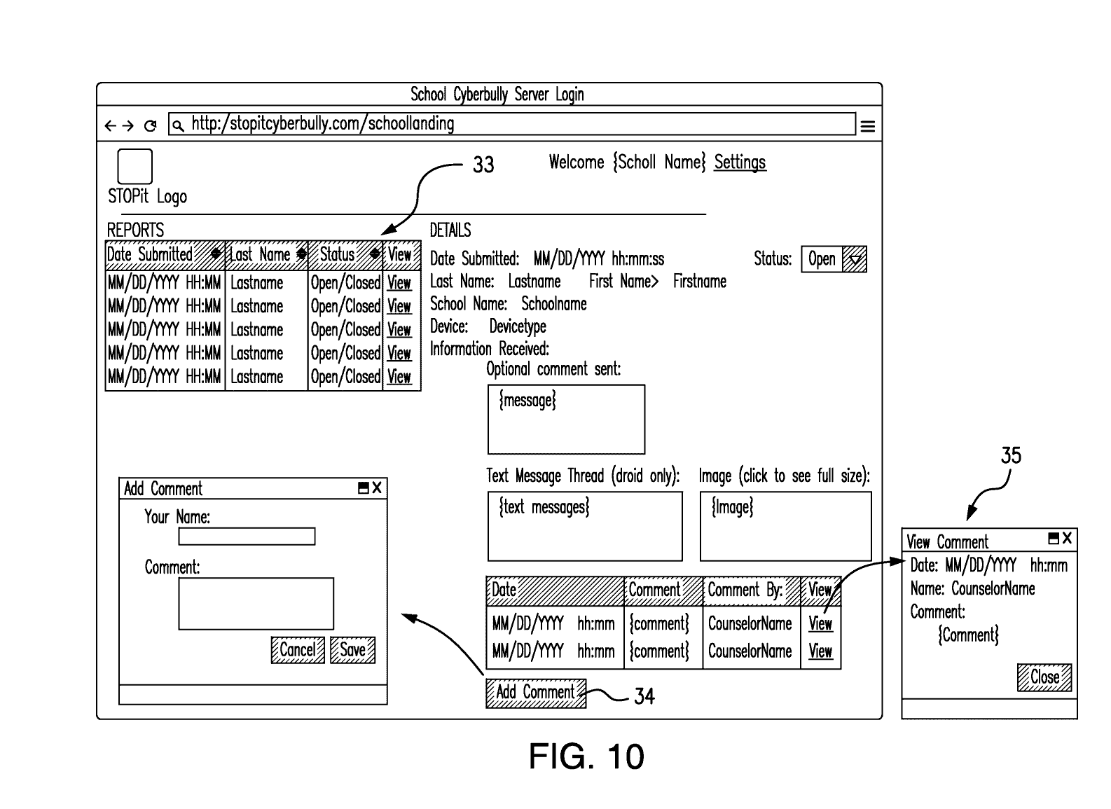

FIGS. 8A and 8B show exemplary screens associated with the application's Setup/Help functions, through which the user can update his/her contact lists and school information. Referring to FIGS. 9 and 10, the version of the application provided to schools includes a DOCUMENTit module. This module allow the school's Cyberbully Contact and/or administrators to access, through the server's website, incident reports received from students 33 and to add comments/updates to the report 34, which are date-time stamped and become part of the school's record 35 of the incident. The DOCUMENTit module thereby enables the school to document its response to cyber-bullying incidents.

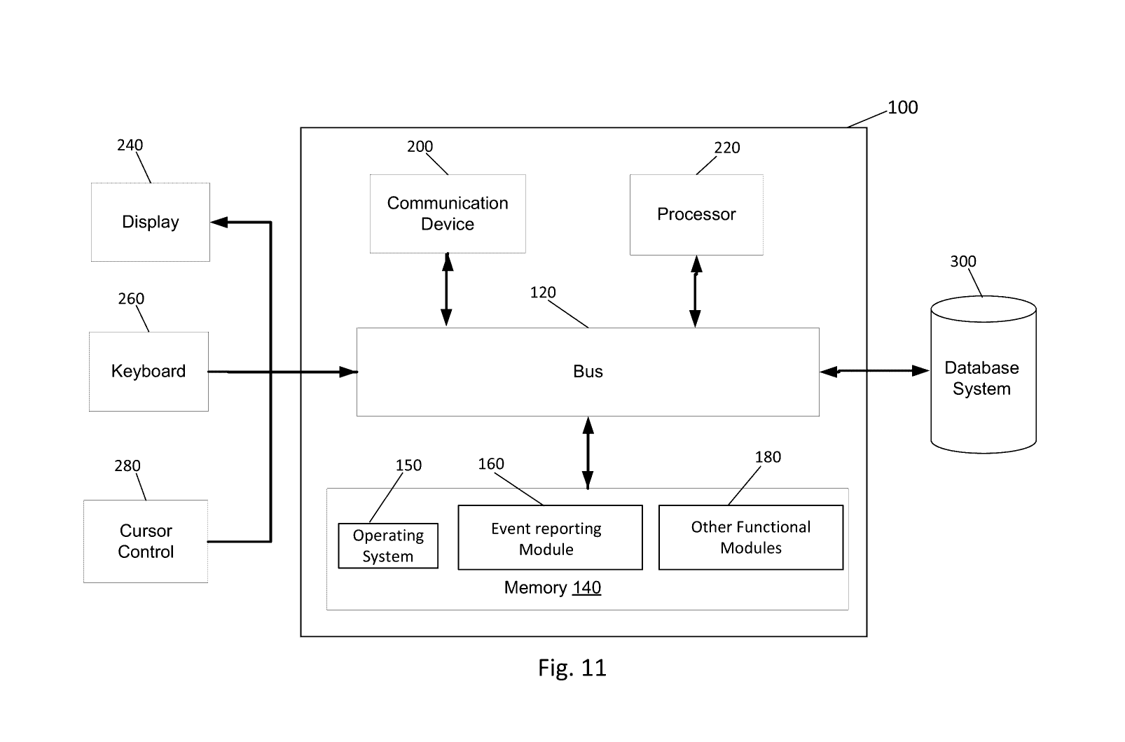

FIG. 11 illustrates a block diagram of an apparatus or system 100, according to one embodiment. According to an embodiment, system 100 may be an event management and reporting system that includes one or more servers. Therefore, in one embodiment, system 100 may be comprised of a server(s), such as an application server or web server. According to certain embodiments, system 100 may be configured to implement the DOCUMENTit module discussed above. However, in this embodiment, the DOCUMENTit module may be referred to as an event reporting module.

According to an embodiment, system 100 includes a bus 120 or other communications mechanism for communicating information between components of system 100. Alternatively, the components of system 10 may communicate with each other directly without the use of bus 120.

System 100 also includes a processor 220, coupled to bus 120, for processing information and executing instructions or operations. Processor 220 may be any type of general or specific purpose processor. System 100 further includes a memory 140 for storing information and instructions to be executed by processor 220. Memory 140 can be comprised of any combination of random access memory (“RAM”), read only memory (“ROM”), static storage such as a magnetic or optical disk, or any other type of machine or computer readable media. System 100 further includes a communication device 200, such as a network interface card or other communications interface, to provide access to a network. As a result, a user may interface with system 100 directly or remotely through a network or any other method.

Computer readable media may be any available media that can be accessed by processor 220 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 220 may be further coupled via bus 120 to a display 240 for displaying information or data to an administrator. A keyboard 260 and a cursor control device 280, such as a computer mouse, may be further coupled to bus 120 to enable a user to interface with system 100.

Processor 220 and memory 140 may also be coupled via bus 120 to a database system 300 and, thus, may be able to access and retrieve information stored in database system 300. Although only a single database is illustrated in FIG. 11, any number of databases may be used in accordance with certain embodiments. In some embodiments, database system 300 may store information related to students, employees, or other individuals associated with organizations that subscribe to the system.

In one embodiment, memory 140 stores software modules that provide functionality when executed by processor 220. The modules may include an operating system 150 that provides operating system functionality for system 100. The memory may also store event reporting module 160, which can provide the functionality for event or incident reporting and processing, according to one embodiment. System 100 may also include one or more other functional modules 180 to provide additional functionality.

Database system 300 may include a database server and any type of database, such as a relational or flat file database. Database system 300 may store attributes related to students, employees, and other individuals associated with subscribing organizations. Database system 300 may also store any other data required by the event reporting module 160, or data associated with system 100 and its associated modules and components.

In certain embodiments, the event reporting module 160, and other functional modules 180 may be implemented as separate physical and logical units or may be implemented in a single physical and logical unit. Furthermore, in some embodiments, the event reporting module 160, and other functional modules 180 may be implemented in hardware, or as any suitable combination of hardware and software.

In one embodiment, the event reporting module 160 is configured to control system 100 to receive a user report of at least one incident of illegal, unethical, bullying, cyber-bullying, harassment, and/or other harmful or inappropriate conduct. System 100 may then be controlled to create an incident report based on the received user report. According to an embodiment, the user report may include metadata comprising a unique code that may be used to anonymously identify a user that the user report is received from.

In certain embodiments, the event reporting module 160 may also be configured to control system 100, in order to initially setup a user's account, to prompt the user, via an application or interface provided by the server, to provide identifying information including their last name, organization name (which may be selected from a drop-down list), student/employee ID, and/or school/work e-mail. In an embodiment, system 100 may then be controlled to use the identifying information to automatically establish the user's account by retrieving previously stored information for the user's organization and initiating the unique code used to anonymously identify the user, and to configure the application to properly work with the organization that the user is associated with. In one embodiment, the identifying information may be securely stored in database system 300. According to an embodiment, the establishing of the user account includes establishing a user name. In an embodiment, the unique code is associated or linked with the user name in database system 300.

In another embodiment, the organization or business may be a treated as a specific type of organization, referred to as a “roster-less organization.” For this type of “roster-less” organization, the organization may be assigned a universal code. Then, all of the employees, students, or individuals associated with the organization receive that same universal code to use/provide when registering with system 100. It is noted that each organization or business is assigned a separate universal code. The universal code for a roster-less organization may be an alphanumeric string, for instance. As an example, a business named Company ABC may be assigned the universal code “CompanyABC” and all of Company ABC's employees are notified of this universal code. As an alternative to the universal code, users (employees, students, etc.) may access a custom website and click a button to generate a random “vanity” code. This random vanity code may then be used the same way as the universal code.

In an embodiment, system 100 may be configured to receive the universal code (or vanity code) from a user or employee of an organization when initiating the app, and system 100 may then be configured to use the received universal code to lookup, generate and/or assign an ID or intellicode to each user (i.e., each employee, student, or member of the organization). For example, this may include pulling an available ID/intellicode for the particular organization out of memory (or a database) and assigning it to the user device (i.e., as a proxy for the user). In another embodiment, system 100 may use the received universal code to generate a unique, random code that will serve as the ID/intellicode. System 100 may then be configured to send the unique ID/intellicode to the user device. The user device may locally store the unique ID/intellicode, and subsequently use the unique ID/intellicode for all communications or transactions with system 100, thereby ensuring total anonymity for the user and secure communications. It is noted that, because system 100 does not collect any identifying information from the user device, system 100 is able to ensure the anonymity for the user; system 100 only needs to use the unique ID/intellicode to uniquely and anonymously identify each user, for example when communicating with the user via the messenger communication.

In another embodiment, system 100 may be further configured to combine the ID/intellicode with an additional ID provided by a vendor of the app store (i.e., an ID that identifies the app and is provided by the app store vendor) in order to produce a new concatenated unique ID for identifying each user. This concatenated unique ID ensures that the user is completely and totally anonymous. As a result, the user can communicate with administrator(s) of the system without sending or receiving any identifying information. The concatenated unique ID may be stored by system 100 in a record for the user in database 300.

It should be noted that, in certain embodiments, the identifying information provided by the user is not used when sending or receiving the user report(s). Rather, in certain embodiments, the unique ID/intellicode or the concatenated unique ID is sent/received as metadata with the user report. It is also noted that the unique ID/intellicode and/or the concatenated unique ID is not viewable by any user or administrator. Rather, the unique ID/intellicode and/or the concatenated unique ID may be used by system 100 to uniquely and anonymously identify each user, for example when communicating with the user via the messenger communication. Therefore, the unique ID/intellicode and/or the concatenated unique code allows the user report to be sent anonymously without information identifying an identity of the user.

According to certain embodiments, the user report includes evidence of at least one incident. The evidence may include text message(s), photo, video, and/or other documentary evidence. In one embodiment, the event reporting module 160 may also be configured to control system 100 to receive the user report via text message, e-mail, and/or other mode of communication. According to other embodiments, the user report may be received from a mobile application or browser application.

In some embodiments, the event reporting module 160 may also be configured to control system 100 to receive information for at least one contact to be added to a contact list that is notified when the at least one incident occurs. In an embodiment, one of the contact(s) may be a default contact that is provided by the organization. This default contact is a contact that is always notified when the at least one incident occurs. According to an embodiment, the event reporting module 160 may also be configured to control system 100 to provide an alert of the at least one incident to the at least one contact stored in the contact list.

In certain embodiments, the incident report generated by system 100 may include information on an alleged perpetrator of the at least one incident, information on the alleged target of the at least one incident, and/or a description of the at least one incident.

According to some embodiments, the event reporting module 160 may also be configured to control system 100 to initiate a secure, anonymous, and two-way communication session between the user (that sent a user report) and an administrator of the system 100. The communication session may be initiated using the unique code and without information indicating an identity of the user. For example, the secure, anonymous, and two-way communication session functionality may be referred to as “messenger,” a chat session, or instant message session. For an organization that has a specific roster of users, when a user record is created (either through a STOPit roster submission or through Manage Account in DOCUMENTit Settings), the user is assigned a unique identifier (e.g., intellicode) as discussed above for activation and incident submission, along with being assigned a unique messenger ID for using messenger (i.e., the secure, anonymous, and two-way communication session).

For devices running the iOS mobile operating system, each of those iOS devices has an “indentifierForVendor”, which is an alphanumeric string that uniquely identifies the device to an application's vendor. In an embodiment, system 100 may collect this unique alphanumeric string when a user registers with system 100. In an embodiment, system 100 is configured to combine or concatenate this unique alphanumeric string (i.e., “indentifierForVendor”) with an intellicode generated by system 100 for each user, to thereby produce a combined unique ID for each user. This combined unique ID (i.e., “indentifierForVendor”+intellicode) may be then be used for an incident submission or messenger submissions. The combined unique ID may be used as the unique code to operate the secure, anonymous, and two-way communication session (i.e., messenger).

For devices running an Android™ operating system, each of those Android™ devices has an “ANDROID_IS”, which is a 64-bit number that is randomly generated upon the device's activation and is generally constant throughout the lifetime of the device. In an embodiment, system 100 may combine this random 64-bit number with an intellicode generated by system 100 for each user, to thereby produce a combined unique ID for each user. This combined unique ID (i.e., “ANDROID_IS”+intellicode) may be then be used for incident submission or messenger submissions. For example, the combined unique ID may be used as the unique code to operate the secure, anonymous, and two-way communication session (i.e., messenger).

When a user wants to initiate a secure, anonymous, and two-way communication session (i.e., messenger), the user may select a messenger button from an interface of a mobile app. In an embodiment, selecting the messenger button may cause the user device to connect to a chat or instant messaging server, such as Openfire, via a protocol, such as XMPP. Then, when the user sends a message, the chat server retrieves the messenger ID, the combined unique code (i.e., identifierForVendor or ANDROID_ID+intellicode), along with the message content and writes them to a database. Messenger data sent from the mobile app to the chat server may be encrypted using 256-bit encryption, and 2048-bit RSA keys. Data stored in the database (e.g., the MySQL relational DB is encrypted using AES-256 encryption). When starting a new conversation, or continuing a conversation after 72 hours have passed, a unique conversation ID may be assigned to the conversation.

For new message notification, when push notifications are turned on in the user device, a push notification may be delivered to the mobile app informing the user of the new message. In an embodiment, one push notification will be sent for every new message. If badge icons are turned on and a push notification is missed on a device, the mobile device may display a badge icon displaying the count of the pending messages on the icon for the mobile app. In another embodiment, upon opening the mobile app, an API call may be used to determine if there are any messages pending. If there are, a pop-up will display in the app notifying the user of unread messages. The pop-up may continue to display on all menu pages within the mobile app while there are unread messages.

An embodiment is able to retrieve the messenger history of a user. For example, when the user opens the messenger page in the mobile app, an API call may be used to retrieve and populate the user's messenger history (e.g., up to 200 messages) from the database. In another embodiment, when a user stays on the messenger page while having a real-time conversation, the API call for a new message notification may be bypassed and the messages will populate directly into the messenger history following all other protocols.

According to another embodiment, an administrator of system 100 may be able to start or initiate the secure, anonymous, and two-way communication session (i.e., messenger) with the user. In this embodiment, to start a conversation with a user, the administrator may select a messenger button from an incident detail page displayed by system 100. For organizations with rosters, the Messenger ID of the mobile app user is looked up based on the intellicode that is associated with a submitter of the incident. For organizations without rosters, the combined unique code (i.e., “identifierForVendor” or “ANDROID_ID”+intellicode) may be looked up based upon the submitter of an incident. Then, to send a message, the administrator enters a message into a conversation modal of system 100. When the administrator clicks Send, system 100 connects to the chat server to write the message to the database. Messenger data sent from system 100 to the chat server may be encrypted using 256-bit encryption, and 2048-bit RSA keys. Data stored in the database (e.g., MySQL relational DB) may be encrypted using AES-256 encryption.

Administrators may also send a message from existing conversations by navigating to the existing conversation via a messenger icon on a navigation panel displayed by system 100, and selecting the conversation they wish to open or continue. If beginning a new conversation, or continuing a conversation after 72 hours have passed, a unique conversation ID may be assigned to the conversation.

In an embodiment, a new email may be sent to alert administrator(s) or report manager(s) in the organization to a new messenger message. According to one embodiment, a maximum of one e-mail will be sent per mobile app user per hour. In certain embodiments, upon logging into system 100, an API call may be used to determine if there are any messages pending, how many, and from how many users. If there are unread messages, a pop up modal will inform the administrator as such. A badge icon may also be displayed on the messenger icon on the navigation panel, and/or a banner notification may be displayed at the bottom of the screen which identifies how many unread messages are pending and from how many app users.

In one embodiment, when an administrator opens a conversation modal, either from the incident detail page or through the messenger navigation (for both an assigned or unassigned conversation), an API call may be used to populate the conversation modal with the Messenger history from the database (e.g., up to 200 messages).

According to an embodiment, if the administrator keeps the conversation modal open while having a real-time conversation, the API call for new message notifications may be bypassed and the messages will populate directly into the conversation modal following all other protocols.

It is noted that the subscribing organization may be, for example, a school, university, company, corporation, or other business or governmental organization or entity. In the example where the organization is a school, the user may be a student and the administrator may be a principle or school counselor, for instance. In the example where the organization is a business, the user may be an employee and the administrator may be a human resources manager, chief executive officer, or other responsible individual, for instance. It is noted that these examples are not exhaustive and embodiments are not limited to only these examples.

According to an embodiment, the event reporting module 160 may also be configured to control system 100 to receive the user report initiated directly from a photo album of a mobile device of the user, without launching the application on the mobile device. In another embodiment, the event reporting module 160 may also be configured to control system 100 to receive a panic/help indication initiated by a user, and to automatically send an alert to a security organization or chaperon with a location of the user and their request for help.

In one embodiment, the event reporting module 160 may be further configured to control system 100 to maintain a library of state, federal, or other administrative regulatory agency compliance reporting requirements, so that an administrator can automatically submit compliance reports to appropriate state, federal, or other regulatory officials.

According to an embodiment, system 100 may be configured to communicate with a mobile device or computer of a user. For example, system 100 may be configured to communicate with a device or computer of the user via the Internet or via a radio access network, such as a cellular communications network. In one embodiment, system 100 may be configured to provide the device of the user with an application interface, such as a mobile “app”.

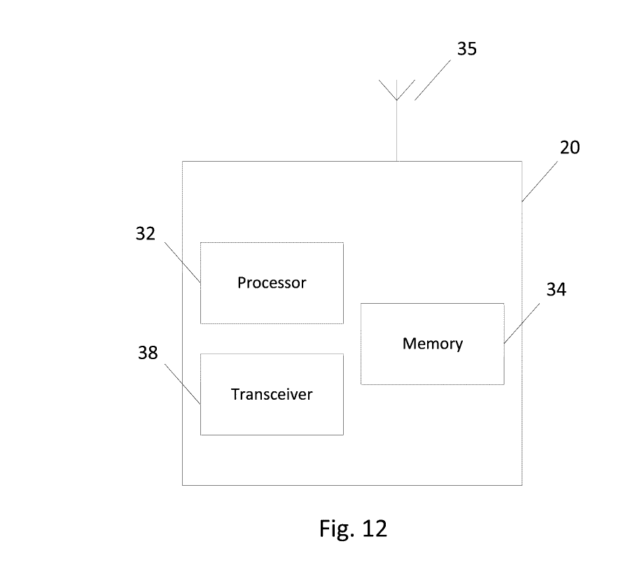

FIG. 12 illustrates an example of an apparatus 20 according to an embodiment. In an embodiment, apparatus 20 may be a mobile device associated with a communications network, such as a user equipment in a cellular communications network. In other embodiments, apparatus 20 may be a computer capable of communicating over the Internet. It should be noted that one of ordinary skill in the art would understand that apparatus 20 may include components or features not shown in FIG. 12.

As illustrated in FIG. 12, apparatus 20 includes a processor 32 for processing information and executing instructions or operations. Processor 32 may be any type of general or specific purpose processor. While a single processor 32 is shown in FIG. 12, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 may further include or be coupled to a memory 34, which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 can be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

In some embodiments, apparatus 20 may also include or be coupled to one or more antennas 35 for transmitting and receiving signals and/or data to and from apparatus 20. Apparatus 20 may further include a transceiver 38 configured to transmit and receive information. For instance, transceiver 38 may be configured to modulate information on to a carrier waveform for transmission by the antenna(s) 35 and demodulate information received via the antenna(s) 35 for further processing by other elements of apparatus 20. In other embodiments, transceiver 38 may be capable of transmitting and receiving signals or data directly.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be a mobile device or computer of a user associated with an organization that subscribes to the event management and reporting system 100. In one embodiment, the event management and reporting system 100 may be configured to receive a report of an incident of bullying, cyber-bullying, harassment, and/or other harmful or inappropriate conduct from apparatus 20.

For instance, the report may be received from an end-user of apparatus 20, such as a student at an educational institution or school that subscribes to the system, or an employee of a business or governmental organization that subscribes to the system. In some implementations, the report may be received from an application (i.e., a mobile app) running on apparatus 20 (i.e., cell phone, tablet, or other user device). In other implementations, the report may be received via a web page running in a web browser of apparatus 20 (e.g., a web browser running on a computer or laptop).

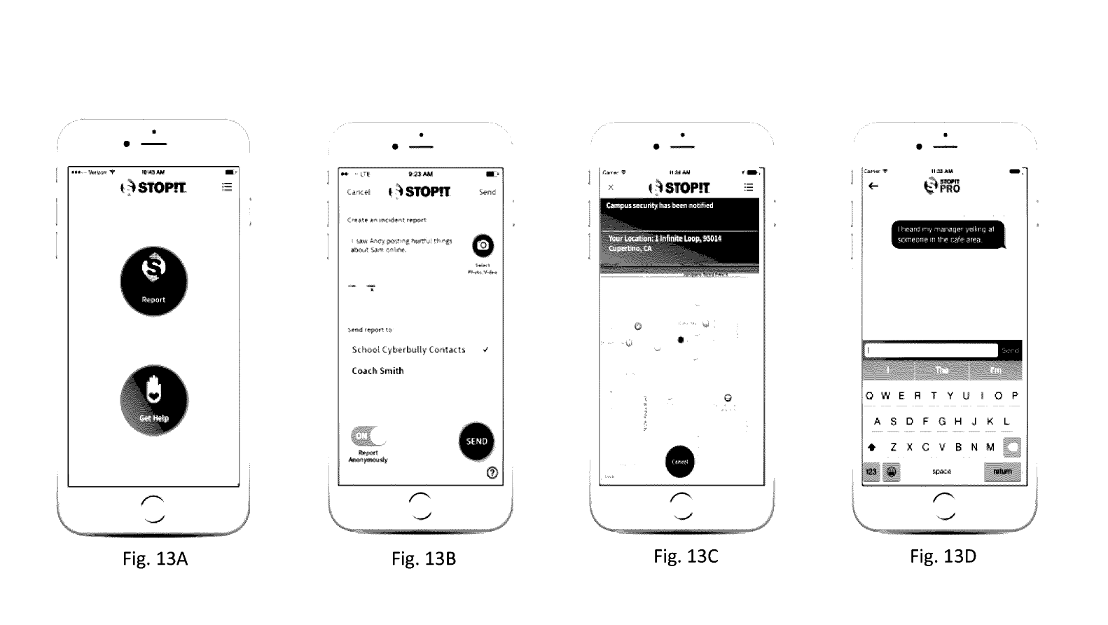

Examples of interfaces of the mobile app (i.e., “STOPit mobile app”) are illustrated in FIGS. 13A-13D. In particular, FIG. 13A illustrates an example user interface for an initial screen of the mobile app, in which a user can select at least between a button for reporting an incident and a “get help” button. When a user touches the button for reporting an incident as shown in FIG. 13A, the mobile app may proceed to display an interface such as that shown in FIG. 13B. The interface of FIG. 13B allows the user to create an incident report for reporting incident(s) anonymously, and may include providing a description of the incident, attaching photo or video evidence of the incident, and selecting (in addition to any default contacts) the recipients of the incident report. When a user selects the “get help” button, the user may be provided with three options that may include: an option for sending a panic alert to get help, an option for activating a messenger functionality for activating a secure, anonymous, two-way communication session with an administrator of system 100, or an option for contacting a crisis center.

When a user touches the button for sending a panic alert to get help, the mobile app may proceed to display an interface such as that shown in FIG. 13C. The interface of FIG. 13C illustrates that administrators and/or local security/police are instantly alerted of the GPS location of the user and that the user location continues to be tracked as they move in order for the local security/police to be dispatched to the user's current location.

FIG. 13D illustrates an example of a secure, anonymous, and two-way communication session between the user (e.g., the user that sent a user report) and an administrator of the system 100. The communication session may be initiated using a unique code, which may be referred to as an intellicode, and without information indicating an identity of the user. In one embodiment, the two-way communication may be secured by means of encryption.

The two-way communication may be used in multiple ways and for different purposes. For example, in one embodiment, the two-way communication may be utilized in real-time to communicate immediate time-sensitive information or threats, for instance. In other embodiments, the two-way communication may be utilized over more extended time periods, for instance, in order to create a dialogue that may help facilitate an investigation or inquiry of illegal, unethical, or inappropriate conduct.

As mentioned above, the system 100 is able to keep the identity of the student or employee reporting the incident anonymous by assigning a random and unique identifier, which may be referred to as an intellicode, to each student or employee of a participating business or institution. Then, when a report of an incident is received from a student or employee, instead of identifying the sender by name or e-mail, the intellicode is received by the event management and reporting system 100 along with the user report. It is noted that the intellicode is not viewable by an administrator of the back-end system or by the user. Rather, the intellicode is securely stored by the system 100 and linked to a corresponding user. As a result, the system 100 allows for anonymous reporting while maintaining the ability to communicate with the individual reporting the incident by securely using their intellicode as encrypted metadata.

After receiving the report of the incident, the system 100 is configured to create an incident report based on the information received in the report of the incident. For example, the information may include evidence of the incident, such as text messages, photos, videos, and/or other documentary evidence. The incident report created by the system 100 may include information on the alleged perpetrator of the incident, information on the alleged target of the incident, and/or other identifying information for the incident.

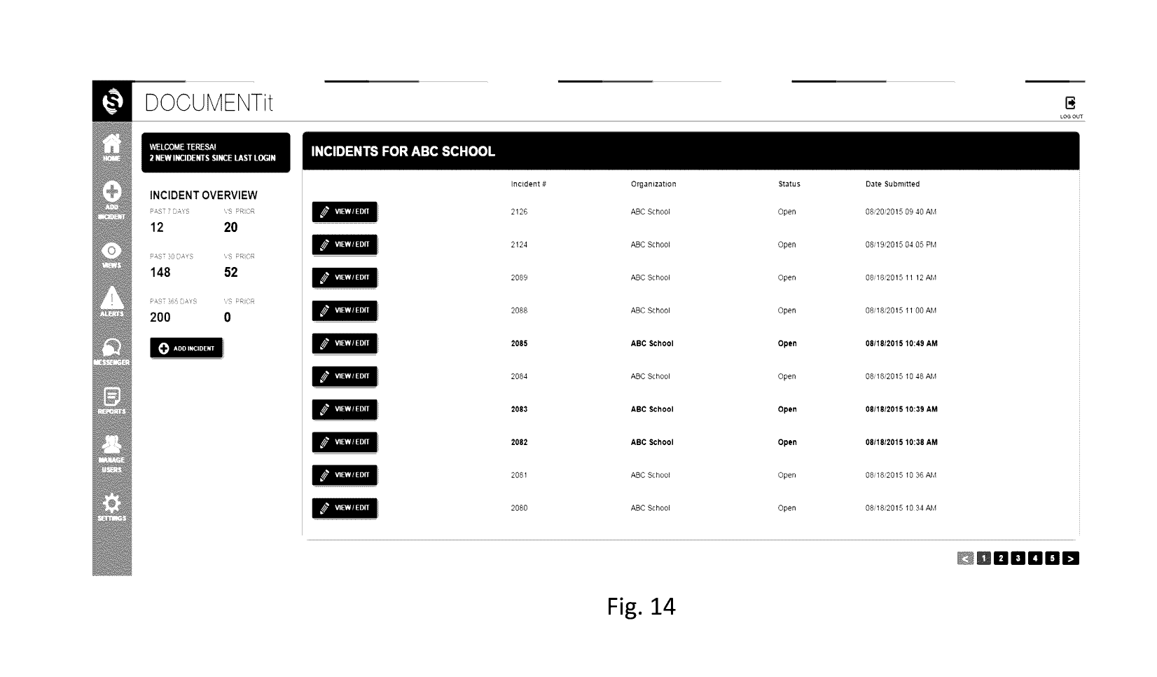

As will be discussed below, FIGS. 14-16 illustrate examples of user interfaces that may be provided by system 100, for example for display on display 240.

FIG. 14 illustrates an example interface that may be used by an administrator of the system 100 for viewing and managing incident reports. As illustrated in FIG. 14, an administrator may add an incident, as well as view/edit existing incidents. Additional tools, such as “alerts,” “messenger,” and “reports,” may also be accessed from the navigation bar located on the left side of the interface. For example, “messenger” is the tool that allows the administrator to initiate the secure, anonymous, two-way communication session with a user or submitter of an incident report.

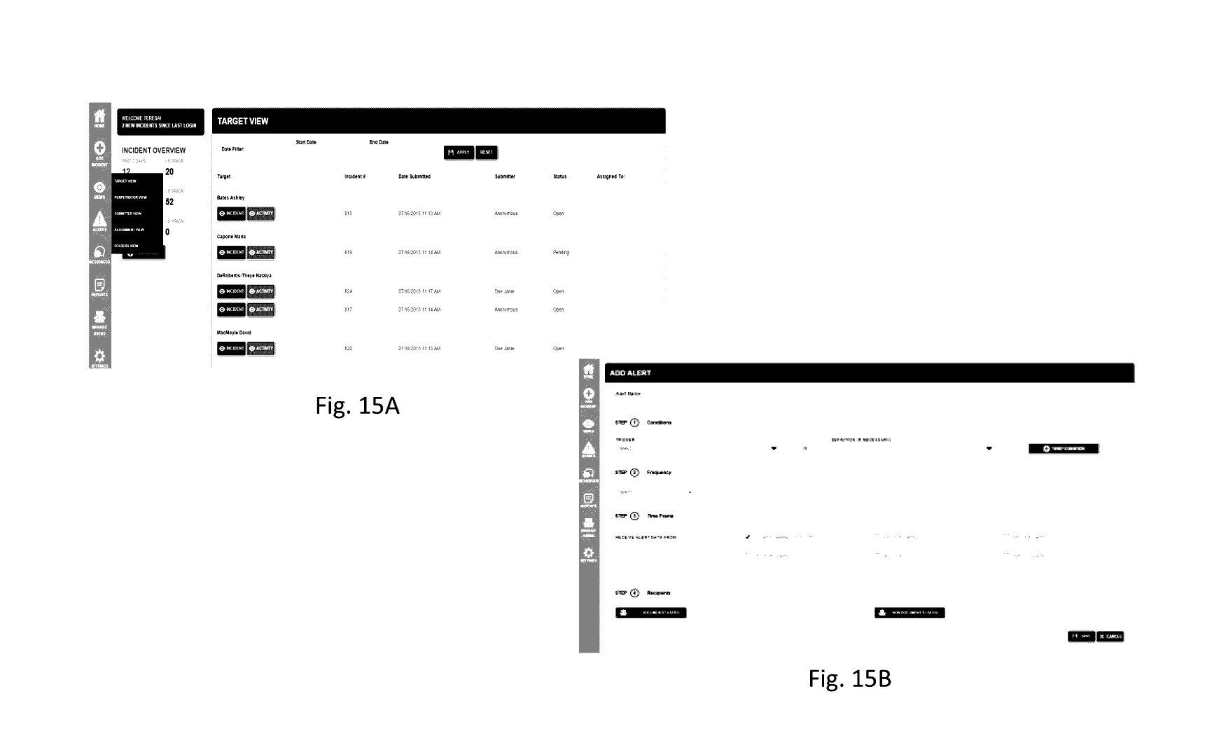

FIG. 15A illustrates an example of a “views” interface that may be utilized by an administrator. “Views” are a way to take a high level look at incidents grouped by a certain category. For instance, the example of FIG. 15A depicts a “Target View” where the incidents are grouped by the target of the incident. This, for example, would allow an administrator to determine whether a certain individual is being particularly targeted.

The system 100 also includes an alerts engine that allows an administrator to specify certain trigger(s), criteria or event(s) that are tracked or monitored by the alerts engine. When the alerts engine detects that the specified trigger(s), criteria or event(s) have occurred, the alerts engine will automatically notify the administrator of the occurrence. As a result, the alerts engine can proactively monitor activity and notify the administrator of certain events with minimal involvement on their part. FIG. 15B illustrates an example interface depicting an “Add Alert” screen, where an administrator can configure a new alert. As illustrated in FIG. 15B, the “Add Alert” screen may include sections for specifying the conditions that trigger an alert, a frequency, a time frame for the specified condition, and a recipient for the alert. Once an alert is setup, the system 100 can measure progress, automatically track activity and notify the desired recipient when it detects certain trends or specific events/conditions.

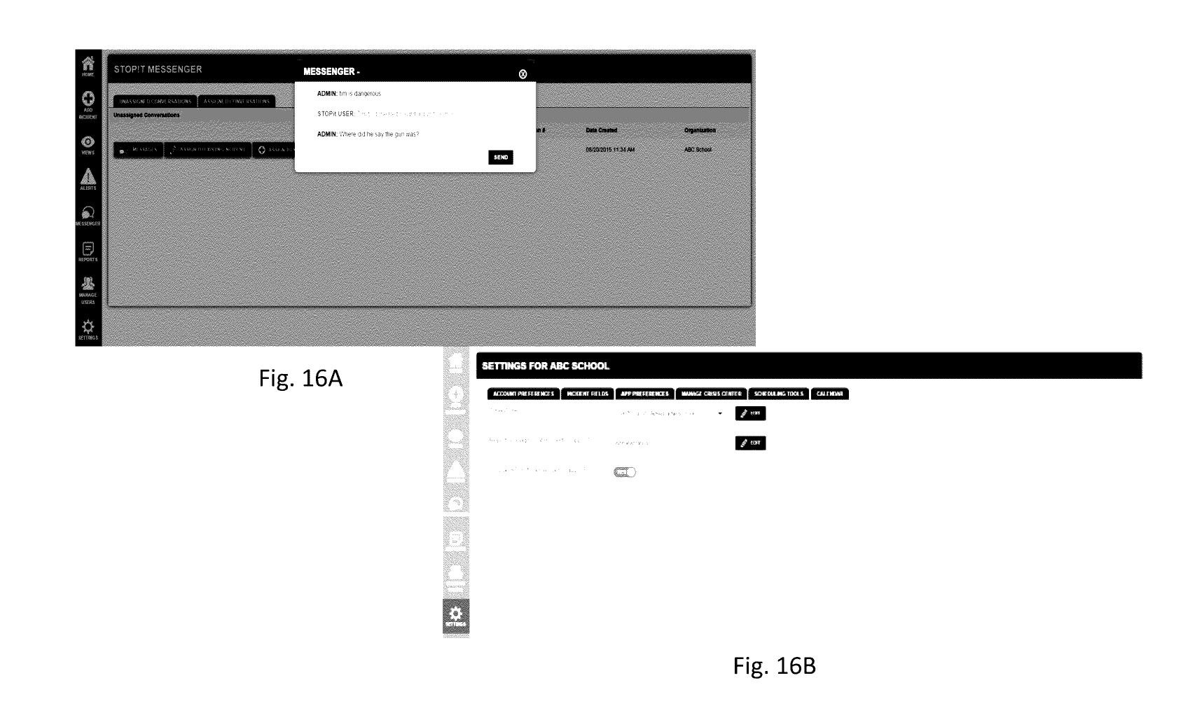

FIG. 16A illustrates an example of an interface for the two-way communications functionality of the system 100. As illustrated in FIG. 16A, the system 100 provides a “messenger” feature allowing an administrator to have a real-time communications session with an anonymous user. Note that FIG. 16A only identifies the user as a “STOPit User,” thereby maintaining their anonymity. This features allows witnesses and whistleblowers to feel more comfortable in providing important information since they do not need to fear retribution.

FIG. 16B illustrates an example of an interface for customizing settings for a particular organization. Customizing incident management settings allows an administrator to set meaningful alerts, run detailed reports, and identify trends specific to that organization. The settings customization interface of FIG. 16B also provides the ability to adjust, set time or date restrictions, or completely disable various features of the system 100 based on the organizations specific needs.

In an embodiment, system 100 may be configured to make a direct request to a social network administrator/server to delete or remove an inappropriate or harmful “post” or entry. For example, according to one embodiment, an interface is provided between system 100 and one or more servers of a social media network such that an administrator of system 100 is able to view a potentially harmful “post” and to submit a programmatic request to the social network server(s) (or administrator) to remove the offending “post”.

In some embodiments, the functionality of any of the methods described herein, such as those illustrated in FIG. 4 or 5 discussed above, may be implemented by software and/or computer program code stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software.

It should be noted that many of the functional features described in this specification have been presented as modules, units, applications or the like, in order to more particularly emphasize their implementation independence. For example, a module or unit may be implemented as a hardware circuit comprising custom VLSI circuits or gate arrays, off-the-shelf semiconductors such as logic chips, transistors, or other discrete components. A module or unit may also be implemented in programmable hardware devices such as field programmable gate arrays, programmable array logic, programmable logic devices or the like.

Modules or units may also be partially implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve its stated purpose.

Indeed, a module of executable code or algorithm could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
creating, by a server, a record to identify a user of an application for reporting at least one incident of illegal, unethical, harmful or other inappropriate conduct,
wherein the application is running on a user device of the user, and
wherein the creating of the record further comprises assigning at least one of: a unique code used to anonymously identify a user that is submitting a report of the at least one incident, and/or a unique messenger ID for use by the user to anonymously send and receive real-time messages via a secure, anonymous, and two-way communication session.

2. The method according to claim 1, wherein the unique code comprises a random code generated by the server and sent to the user device of the user, and wherein the random code is utilized by the application to anonymously communicate with the server without identifying the user.

3. The method according to claim 1, wherein the unique messenger ID comprises a combination of a unique ID assigned to the user and a unique alphanumeric code associated with a mobile device of the user.

4. The method according to claim 1, further comprising initiating the secure, anonymous, and two-way communication session between the user and an administrator of the server.

5. The method according to claim 3, wherein the initiating comprises initiating the communication session using the unique messenger ID and without information indicating an identity of the user.

6. The method according to claim 1, wherein, when beginning a new communication session, the method further comprises assigning a unique conversation ID to identify the communication session.

7. An apparatus, comprising:
at least one processor; and
at least one memory including computer program code,
the at least one memory and the computer program code are configured, with the at least one processor, to cause the apparatus at least to
create a record to identify a user of an application for reporting at least one incident of illegal, unethical, harmful or other inappropriate conduct,
wherein the application is running on a user device of the user, and
wherein the creating of the record further comprises assigning at least one of: a unique code used to anonymously identify a user that is submitting a report of the at least one incident, and/or a unique messenger ID for use by the user to anonymously send and receive real-time messages via a secure, anonymous, and two-way communication session.

8. The apparatus according to claim 7, wherein the unique code comprises a random code generated by the apparatus and sent to the user device of the user, and wherein the random code is utilized by the application to anonymously communicate with the apparatus without identifying the user.

9. The apparatus according to claim 7, wherein the unique messenger ID comprises a combination of a unique ID assigned to the user and a unique alphanumeric code associated with a mobile device of the user.

10. The apparatus according to claim 7, wherein the at least one memory and the computer program code are further configured, with the at least one processor, to cause the apparatus at least to initiate the secure, anonymous, and two-way communication session between the user and an administrator of the apparatus.

11. The apparatus according to claim 10, wherein the communication session is initiated using the unique messenger ID and without information indicating an identity of the user.

12. The apparatus according to claim 7, wherein, when beginning a new communication session, the at least one memory and the computer program code are further configured, with the at least one processor, to cause the apparatus at least to assign a unique conversation ID to identify the communication session.

13. A computer program, embodied on a non-transitory computer readable medium, the computer program configured to control a processor to perform a process, comprising:
creating a record to identify a user of an application for reporting at least one incident of illegal, unethical, harmful or other inappropriate conduct,
wherein the application is running on a user device of the user, and
wherein the creating of the record further comprises assigning at least one of: a unique code used to anonymously identify a user that is submitting a report of the at least one incident, and/or a unique messenger ID for use by the user to anonymously send and receive real-time messages via a secure, anonymous, and two-way communication session.
